(19) United States
(12) Patent Application Publication
(10) Pub. No.: US 2021/0152791 A1
(43) Pub. Date: May 20, 2021

(54) CORRECTION FOR LATERAL CHROMATIC ABERRATION IN IMAGES

(71) Applicant: Facebook Technologies, LLC, Menlo Park, CA (US)

(72) Inventors: Manoj Bikumandla, Union City, CA (US); Andrew Matthew Bardagjy, Seattle, WA (US)

(21) Appl. No.: 16/688,964

(22) Filed: Nov. 19, 2019

(51) Int. Cl. H04N 9/04; H04N 13/15; H04N 13/246; H04N 5/235

(52) U.S. Cl. CPC H04N 9/04517; H04N 5/2352; H04N 13/246; H04N 13/15

(57) ABSTRACT

A camera calibration system includes at least two monochrome cameras and a controller. Each monochrome camera includes a sensor array and a sparse array of filter elements. The sensor array captures one or more images of a local area and includes a plurality of broadband pixels. The sparse array of filter elements is coupled to a portion of the broadband pixels. At least some of the portion of the broadband pixels are along a periphery of the sensor array. Each of the filter elements has a respective passband that is narrower than a passband of the broadband pixels. The controller corrects for lateral chromatic aberration in an image generated from the images captured by the monochrome cameras by using calibration information and portions of the image corresponding to the portion of the broadband pixels that are coupled to the sparse array of filter elements.

### FIELD OF THE INVENTION

This disclosure relates generally to correcting for chromatic aberration, and more specifically to correction for lateral chromatic aberration in a camera assembly of a stereo based depth system.

### BACKGROUND

Head-mounted display (HMD) system typically uses one or more optical elements to provide a magnified view of its display. However, HMD systems usually use positive optical elements that are refractive in nature. These optical elements cause chromatic aberration, which may degrade image quality and introduce error in stereo matching algorithm. Conventional solutions correct for chromatic aberration is to use an achromatic optical element (generally includes 2 or more optical elements). However, this solution adds optical components, increases form factor, and can be expensive.

### SUMMARY

Embodiments of the present disclosure support a camera calibration system and method for generating calibrating information for a camera assembly and correcting for lateral chromatic aberration in images captured by the camera assembly.

In some embodiments, the camera assembly captures one or more images of a target image. The camera assembly includes at least two monochrome cameras. Each monochrome camera of the camera calibration system captures image data of the target image. An image captured by the camera assembly can be a stereo image generated based on the image data captured by the monochrome cameras. The target image is displayed in a target band. Each monochrome camera includes a sensor array and a sparse array of filter elements. The sensor array includes a plurality of broadband pixels. The sparse array of filter elements is coupled to a portion of the broadband pixels. At least some of the portion of the broadband pixels are along a periphery of the sensor array. Each of the filter elements has a respective passband that is narrower than a passband of the broadband pixels. Offsets for light in the target band captured at the portion of the broadband pixels that is coupled to the sparse array of filter elements are determined. Offsets for other broadband pixels of the sensor arrays of the monochrome cameras are extrapolated. Calibration information for correcting lateral chromatic aberration in the camera assembly is generated based on the determined offsets and extrapolated offsets. The calibration information comprising information describing offset for light in a target band as a function of positions of at least some of the plurality of broadband pixels.

A controller of the camera calibration system corrects for lateral chromatic aberration in the one or more images captured by the camera assembly. The controller uses the calibration information and portions of the one or more captured images of the local area corresponding to the portion of the broadband pixels that are coupled to the sparse array of filter elements.

### BRIEF DESCRIPTION OF THE DRAWINGS

FIG. 1 illustrates lateral chromatic aberration of an optical element, in accordance with one or more embodiments.

FIG. 2 is a block diagram of a camera calibration system coupled to a display device, in accordance with one or more embodiments.

FIG. 3 is a perspective view of a headset implemented as a head-mounted display, in accordance with one or more embodiments.

FIG. 4A illustrates a sensor array of a monochrome camera, in accordance with one or more embodiments.

FIG. 4B illustrates another sensor array of a monochrome camera, in accordance with one or more embodiments.

FIG. 5 illustrates sensor arrays of a camera assembly comprising a color camera and two monochrome cameras, in accordance with one or more embodiments.

FIG. 6 is a flowchart illustrating a method for generating calibration information used for correcting lateral chromatic aberration, in accordance with one or more embodiments.

FIG. 7 is a flowchart illustrating a method for correcting lateral chromatic aberration, in accordance with one or more embodiments.

FIG. 8 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments relate to a camera calibration system that corrects for lateral chromatic aberration in images captured by a camera assembly comprising at least two monochrome cameras. The two monochrome cameras are separated by a base line and can capture images of one or more objects in a local area from different angles. The camera assembly can be a component of a stereo based depth system. Depth information of the local area can be extracted from the images by examining positions of an object in the images.

Each monochrome camera includes a sensor array and a sparse array of filter elements. The sensor array includes broadband pixels that can capture images of a local area. The filter elements are coupled to broadband pixels at a periphery of the sensor array. In some embodiments, some of the filter elements are coupled to broadband filters at a center of the sensor array. Each of the filter elements have a passband that is significantly narrower than a passband of the corresponding broadband pixels. For example, the broadband pixels have a passband that includes a visible band (e.g., ˜380 nm to 750 nm) and at least a portion of an infrared band (e.g., ˜750 nm to 1 mm). The passband of the filter elements can be a subset of the visible band and/or a subset of the infrared band. A subset of the visible band can be a band corresponding to a color, i.e., a color channel, such as 500-550 nanometers for green. The passband of the filter elements can also include an infrared band in addition or alternative to the color channel.

Each monochrome camera captures one or more images of a target image that is displayed in a target band. The target band can be a color channel of a visible band or an infrared band. The camera calibration system generates a stereo image by combining images captured by the at least two monochrome cameras and compares portions of the stereo image that correspond to the broadband pixels coupled to the filter elements with corresponding portions of the target image. Based on the comparison, the camera calibration system determines offsets for light in the target band captured at the broadband pixels coupled to the filter elements and extrapolates offsets for the rest of the broadband pixels of the sensor array of the monochrome cameras. Based on the determined offsets and extrapolated offsets, the camera calibration system generates calibration information that describes offset for light in the target band as a function of positions of broadband pixels. In some embodiments, an offset is a shift in a position of a point of the local area in the captured images. The camera calibration system applies the calibration information to correct for lateral chromatic aberration in an image of a local area captured by the monochrome camera, e.g., for determining depth information of the local area.

The filter elements can have a passband that is a subset of the visible band, the correction of lateral chromatic aberration using the filter elements can improve stereo view of the location area that captured by the camera assembly. Also, determination of depth information of the local area based on images captured by the camera assembly can be improved by using filter elements that have a passband in the infrared band. Furthermore, filter elements having passband in an infrared band can also be used to detect wavelength shift in emitted light, e.g., light emitted by a peripheral device associated with the camera assembly and/or light projected by an illuminator associated with the camera assembly.

The camera calibration system is more advantageous than convention techniques for correction lateral chromatic aberration. It does not require additional optical components other than overlaying the existing sensor array of the camera with filter elements. It also does not increase form factor or volume of the headset. Rather, it reduces complexity of module design and is less expensive.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

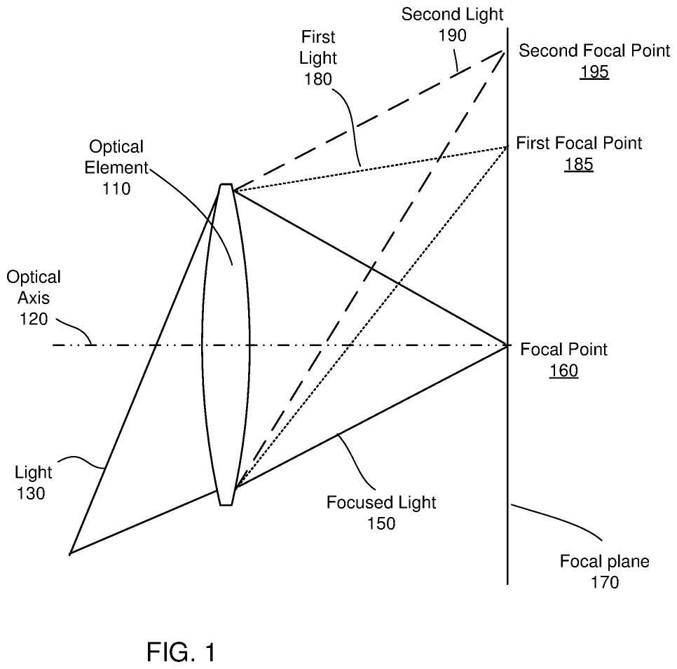

FIG. 1 illustrates lateral chromatic aberration of an optical element 110, in accordance with one or more embodiments. The optical element 110 is a positive optical element that refracts light projected onto it. The optical element 110 may be made of various types of materials, such as plastic, glass, crystalline materials, or some combination thereof.

As shown in FIG. 1, the optical element 110 has an optical axis 120. Light 130 is project toward the optical element 110. The light 130 comprises various wavelengths of light. In some embodiments, a band of the light 130 includes various color channels of a visible band.

The optical element 110 is configured to focus the light 130 at a focal point 160 on a focal plane 170. However, lateral chromatic aberration in the optical element 110 causes different wavelengths to be focused at different positions on the focal plane 170. As shown in FIG. 1, the optical element 110 focuses a first light 180 at a first focal point 185 and focuses a second light 190 at a second focal point 195. The first light 180 (e.g., red light) has a larger wavelength than a wavelength of the second light 190 (e.g., blue light), and the first focal point 185 is below the second focal point 195. Lateral chromatic aberration in an optical element of a camera can cause aberration in images captured by the camera, such as color shifting, purple fringing, blur, etc. Lateral chromatic aberration also affects black-and-white images. Although there are no colors in black-and-white images, chromatic aberration can blur the images.

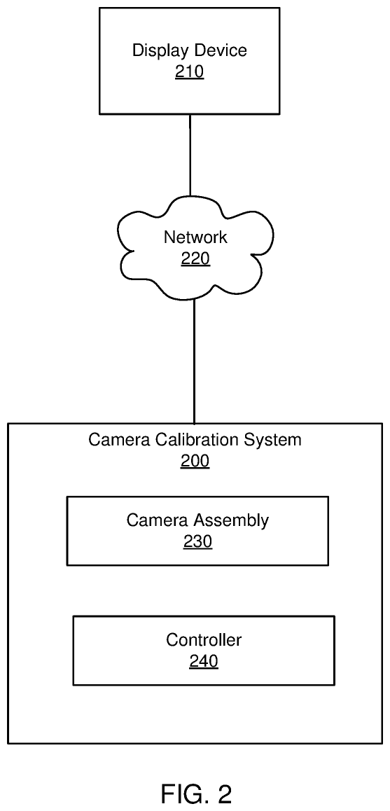

FIG. 2 is a block diagram of a camera calibration system 200 coupled to a display device 210, in accordance with one or more embodiments. The camera calibration system 200 generates calibration information for correcting lateral chromatic aberration in images captured by a camera assembly 230. The camera calibration system 200 includes the camera assembly 230 and a controller 240. In some embodiments, some or all of the camera calibration system 200 is integrated into a headset. In other embodiments, functionality of the camera calibration system 200 can be performed by third party work stations coupled to the headset. The camera calibration system 200 may be a part of an imaging system of a headset that generates depth information and color images of a local area surrounding the headset.

A network 220 couples the display device 210 to the camera calibration system 200. The network 220 may include any combination of target area and/or wide area networks using both wireless and/or wired communication systems. For example, the network 220 may include the Internet, as well as mobile telephone networks. In one embodiment, the network 220 uses standard communications technologies and/or protocols. Hence, the network 220 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 220 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 220 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. The network 220 may also connect multiple display devices to the headset 220 or connect the display device 210 to multiple headsets.

The display device 210 displays a target image in a target band. The target image is an image of a specific pattern that can be used to detect aberrations in the image caused by lateral chromatic aberration. In some embodiments, the target image includes a sine wave pattern, such as square grid or circular grid of different sizes, etc. In some embodiments, the target band is a color channel (e.g., green, red, blue, some other color, etc.) of a visible band or an infrared band. The target band can also be an infrared band. The display device 210 can display the target image according to an instruction received from the camera calibration system 200, such as the controller 240 of the camera calibration system 200, through the network 220. The instruction can include specification of a pattern in the target image, the target band, a period of time of displaying the target image, or other information related to display of the target image by the display device 210. The display device 210 comprises one or more electronic display panel. Examples of an electronic display panel include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, or some combination thereof.

The camera assembly 230 is configured to capture images of a local area, e.g., an area surrounding the headset. The local area may be a room that a user wearing the headset is inside, or the user wearing the headset may be outside and the local area is an outside area. An image captured by the camera assembly 230 can have poor quality due to optical errors in the camera assembly 230, such as lateral chromatic aberration of an optical assembly of the camera assembly 230, shifts in positions of the camera assembly 230, wear to tear of the camera assembly 230, etc.

The camera assembly 230 captures one or more images, e.g., stereo images, of the target image in accordance with an instruction from the controller 240. The instruction can include specification of the number of images to be captured by the camera assembly 230, times when images of the target image should be captured, or other parameters regarding capturing images of the target image. The camera assembly 230 can include at least two monochrome cameras. Each captured image can be generated by combining image data generated by the monochrome cameras. The captured images of the target image can be used for generating the calibration information.

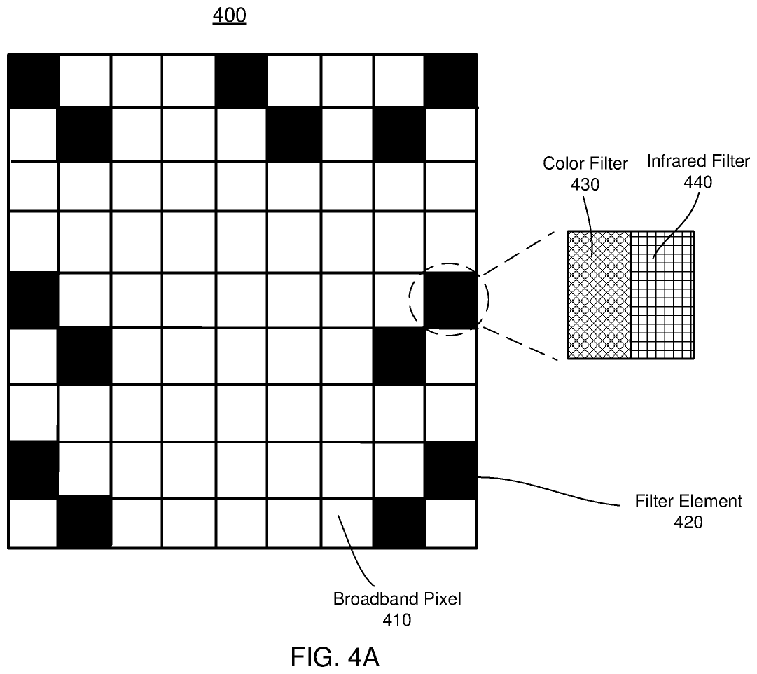

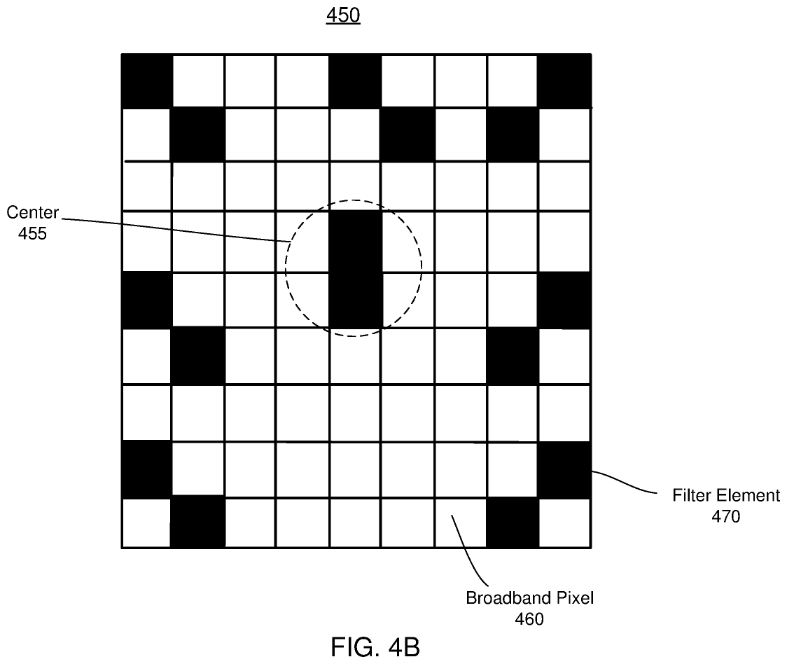

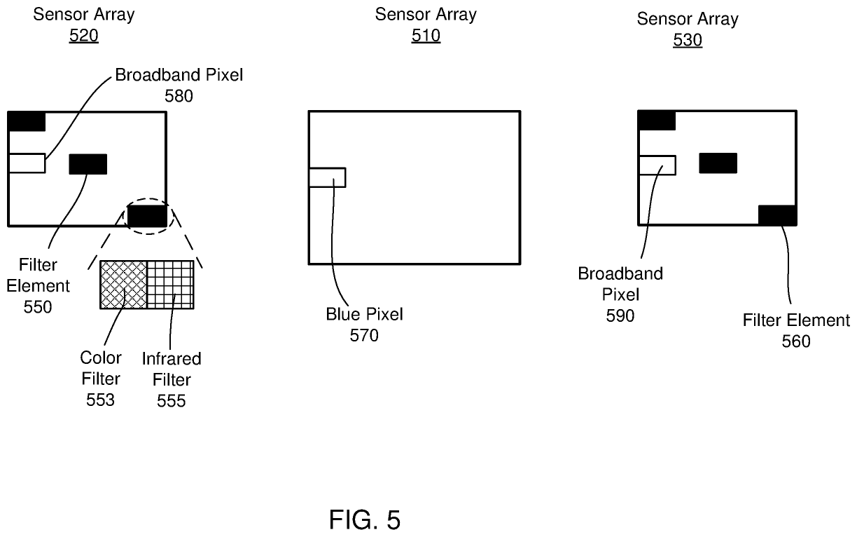

Each monochrome camera includes a sensor array and a sparse array of filter elements. The sensor array captures images of the local area. The sensor array includes a plurality of broadband pixels. The filter elements are coupled to a subset of the broadband pixels. Some broadband pixels in the subset are arranged along a periphery of the sensor array. In some embodiments, the camera assembly 230 has one filter element for every 32 broadband pixels. Each of the filter elements has a passband that is narrower than a passband of the broadband pixels. For example, the passband of the broadband pixels includes a visible band and an infrared band, and the passband of a filter element is a color channel of a visible band and/or an infrared band (such as a bandwidth of at least 5 nanometers). In some embodiments, the camera assembly 230 can include a RGB (red-green-blue) sensor array. More details regarding sensor arrays of the camera assembly 230 are described below in conjunction with FIGS. 4A, 4B and 5.

The controller 240 generates the instruction to the display device 210 for displaying the target image and the instruction to the camera assembly 230 to capture the one or more images of the target image. For instance, the controller 240 selects a pattern and instructs the display device 210 to display an image of the pattern, i.e., the target image, in the target band within a period of time. The controller 240 also instructs the camera assembly 230 to capture the one or more images of the target image within the period of time. An image captured by the camera assembly 230 can be a stereo image or reconstructed image generated from images captured by monochrome cameras of the camera assembly 230.

The controller 240 receives the one or more images captured by the camera assembly 230 and generates calibration information for the camera assembly 230 based on the one or more captured images. The captured images are at wavelengths corresponding to the passband of the filter elements. In some embodiments, the controller 240 extracts portions of each captured image that corresponds to the broadband pixels that are coupled to the filter elements. The controller 240 compares the extracted portions of each captured images with corresponding portions of the target image. From the differences between the extracted portions of the captured image and the corresponding portions of the target image, the controller 240 determines aberrations in the portions of the captured image based on the comparison. The aberrations are at least partially caused by lateral chromatic aberration. Based on the determined aberrations, the controller 240 determines offsets for counterbalancing the aberrations. Each offset can correspond to a broadband pixel of the sensor array of the camera assembly 230 that is coupled to a filter element.

The controller 240 extrapolates offsets for the other broadband pixels of the sensor array that are not coupled to the filter elements based on the determined offsets. For instance, the controller 240 determines that the offset for one or more broadband pixels in a center of the sensor array is zero. The controller 240 then extrapolates the offsets for these other for other broadband pixels based on the determined offsets for the broadband pixels that is coupled to the sparse array of filter elements and the zero offset for the one or more broadband pixels in the central region of the sensor array. In some embodiments, the extrapolation is based on a camera projection model.

In some embodiments, the controller 240 determines an offset function that describes as a function of distance from the center of the sensor array how offset changes. The controller 240 determines the offset function using the determined offset values and information describing the optical assembly of the camera assembly 230, such as indices of refraction, curvature of surfaces, lens thickness, etc. The controller 240 generates the calibration information based on the offset function.

The controller 240 uses the calibration information to correct for lateral chromatic aberration for the passbands of the filter elements in images captured by the camera assembly 230. For example, the controller 240 uses the calibration information to eliminate aberrations in some (e.g., correspond to the portion of the broadband pixels that are coupled to the sparse array of filter elements) or all of an image captured by the camera assembly 230.

The controller 240 can also use corrected images to generate depth information of the local area. The controller 240 can also use the depth information to generate content to be presented to a user by the headset 210. The content can be virtual images, or a mixture of virtual images and real images of the local area. In some embodiments, the controller 240 generates a model of the local area based on the depth information. The controller 240 can also generate position information of an object in the local area that indicates a position of the object in the model. For example, the depth information indicates that the object has moved further from the headset, the controller 240 generates content for the headset that mirrors the object's movement in an augmented reality environment.

In some embodiments, the controller 240 uses images captured by other cameras of the camera assembly 230 to correct for the lateral chromatic aberration in images captured by the camera. For instance, the controller 240 can use images captured by a color camera to correct for lateral chromatic aberration in images captured by the monochrome cameras. For instance, the controller 240 can use color images generate by the color camera to generate calibration information at different color bands from the passband of the filter elements. In some embodiments, the controller 240 also generates instructions for a peripheral device. The peripheral device projects light that can be captured by the camera assembly 230. In some embodiments, the peripheral device is a hand-held controller coupled to the headset. The projected light can be used for tracking positions/orientations of the peripheral device. The projected light can be in an infrared band, and the passband of some of the filter elements of a monochrome camera can be near IR band, e.g., having a bandwidth of at least 5 nanometers. The controller 240 detects a wavelength shift in light filtered by the portion of the filter elements and captured by a corresponding portion of the broadband pixels. For instance, the controller 240 obtains an intended wavelength of light, e.g., from a component associated with the projected light that controls projection of the light. The intended wavelength is a wavelength of light that the peripheral device should project. The controller 240 determines a wavelength of the projected light based on one or more image of the peripherical device captured by the camera assembly 230 and compares the intended wavelength with the wavelength of the projected light to detect the wavelength shift. In response to the detection, the controller 240 generates instructions for the peripheral device and instructs the peripheral device to adjust a wavelength of the emitted light. The generated instruction can include an amount of adjustment determined by the controller 240 based in part on the detected wavelength shift.

The controller 240 can also instruct the peripheral device (or a different system, e.g., an eye tracking system) to adjust brightness of emitted light so that it is detectable over ambient light. The controller 240 detects a brightness in ambient light filtered by the portion of the filter elements and captured by a corresponding portion of the broadband pixels. In response to the detection, the controller 240 generates instructions for the peripheral device or the different system and instructs it to adjust a brightness of the emitted light. For instance, the controller 240 instructs the peripheral device to increase the brightness of its emitted light to a level that is higher than the detected brightness of the ambient light. The generated instruction can include an amount of adjustment determined by the controller 240 based in part on the detected brightness of the ambient light.

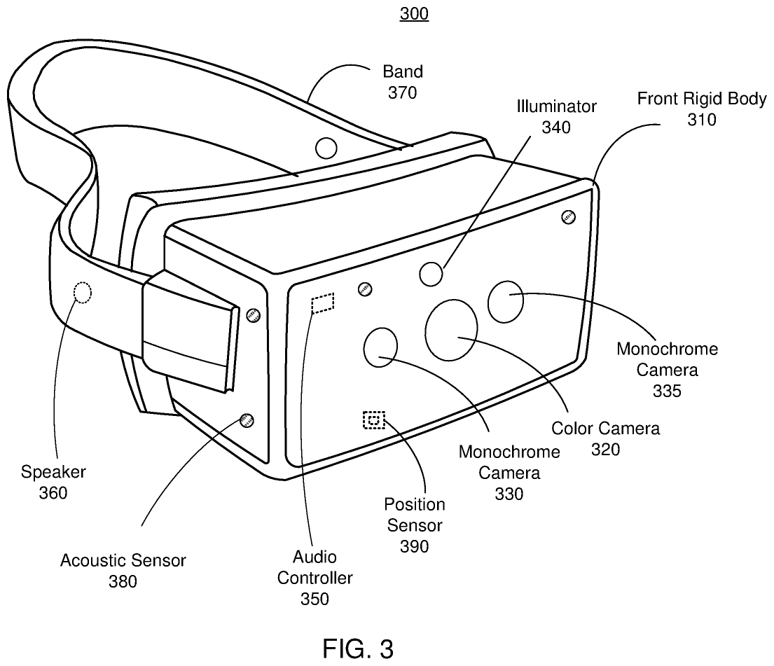

FIG. 3 is a perspective view of a headset 300 implemented as a HMD, in accordance with one or more embodiments. The headset 300 is an embodiment of the headset 220 in FIG. 2. In embodiments where the headset 300 is used in an AR system and/or a MR system, portions of a front side of the headset 300 are at least partially transparent in the visible band (˜380 nm to 750 nm), and portions of the headset 300 that are between the front side of the headset 300 and an eye of the user are at least partially transparent (e.g., a partially transparent electronic display).

In general, the headset 300 may be worn on the face of a user such that content (e.g., media content) is presented using a display assembly and/or an audio system. However, the headset 300 may also be used such that media content is presented to a user in a different manner. Examples of media content presented by the headset 300 include one or more images, video, audio, or some combination thereof.

The headset 300 includes a front rigid body 310, a depth camera assembly (DCA) that includes two monochrome cameras 330 and 335, a color camera 320, an illuminator 340, an audio controller 350, speakers 360, a band 370, acoustic sensors 380, and a position sensor 390. The headset 300 also includes components partially shown or not shown in FIG. 3, such as a display assembly including one or more display elements and an audio system. While FIG. 3 illustrates the components of the headset 300 in example locations on the headset 300, the components may be located elsewhere on the headset 300, on a peripheral device paired with the headset 300, or some combination thereof. For example, the speakers 360 may be located in various locations, such as coupled to the band 370 (as shown in FIG. 3), coupled to the front rigid body 310, or may be configured to be inserted within the ear canal of a user. There may be more or fewer components on the headset 300 than what is shown in FIG. 3.

The front rigid body 310 holds the other components of the headset 300. The front rigid body 310 includes a front part that holds the one or more display elements. The one or more display elements provide light to a user wearing the headset 300. The headset 300 can include a display element for each eye of a user.

In some embodiments, a display element generates image light that is provided to an eyebox of the headset 300. The eyebox is a location in space that an eye of user occupies while wearing the headset 300. For example, a display element is an electronic display panel. Examples of an electronic display panel include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, or some combination thereof.

In some embodiments, the headset 300 generates VR content. Alternatively, in some embodiments, one or both of the display elements are at least partially transparent, such that light from the local area may be combined with light from the one or more display elements to produce AR and/or MR content.

Note that in some embodiments, the display element may include an additional optics block (not shown). The optics block may include one or more optical elements (e.g., lens, Fresnel lens, etc.) that direct light from the display element to the eyebox. The optics block may, e.g., correct for aberrations in some or all of the image content, magnify some or all of the image, or some combination thereof.

The DCA determines depth information for a portion of a local area surrounding the headset 300. The DCA includes the two monochrome cameras 330 and 335, a DCA controller (not shown in FIG. 3), and the illuminator 340. The DCA can be an embodiment of the camera assembly 230 in FIG. 2. In some embodiments, the illuminator 340 illuminates a portion of the local area with light. The light may be, e.g., structured light (e.g., dot pattern, bars, etc.) in the infrared (IR), IR flash for time-of-flight, etc. In some embodiments, the monochrome cameras 330 and 335 capture, from different perspectives, images of the portion of the local area that include the light from the illuminator 340. The monochrome cameras 330 and 335 can be separated by a base line. The DCA can extract three-dimensional information of objects of the local area from the captured images. However, a position of an object determined by the DCA can be off due to lateral chromatic aberration of optical elements of the monochromatic cameras 330 and 335 or other imperfections of the monochromatic cameras 330 and 335. The DCA controller can generate calibration information for the monochromatic cameras 330 and 335 and correct for lateral chromatic aberration in the captured images using the calibration information. More details about the monochrome cameras 330 and 335 are described below in conjunction with FIGS. 4A, 4B, and 5.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 340), some other technique to determine depth of a scene, or some combination thereof.

The audio system provides audio content. In some embodiments, the audio system includes speakers 360, acoustic sensors 380, and an audio controller 350. The speakers 360 present sound to user. Although the speakers 360 are shown exterior to the front rigid body 310, the speakers 360 may be enclosed in the front rigid body 310. In some embodiments, instead of individual speakers for each ear, the headset 300 includes a speaker array comprising multiple speakers integrated into the front rigid body 310 to improve directionality of presented audio content. The acoustic sensors 380 detects sounds within the local area of the headset 300. The acoustic sensor 380 captures sounds emitted from one or more sound sources in the local area (e.g., a room). Each acoustic sensor is configured to detect sound and convert the detected sound into an electronic format (analog or digital). The acoustic sensors 380 may be acoustic wave sensors, microphones, sound transducers, or similar sensors that are suitable for detecting sounds.

The audio controller 350 processes information from the sensor array that describes sounds detected by the sensor array. The audio controller 350 may comprise a processor and a computer-readable storage medium. The audio controller 350 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 360, or some combination thereof.

The position sensor 390 generates one or more measurement signals in response to motion of the headset 300. The position sensor 390 may be located on a portion of the front rigid body 310 of the headset 300. The position sensor 390 may include an inertial measurement unit (IMU). Examples of position sensor 390 include: one or more accelerometers, one or more gyroscopes, one or more magnetometers, another suitable type of sensor that detects motion, a type of sensor used for error correction of the IMU, or some combination thereof. The position sensor 390 may be located external to the IMU, internal to the IMU, or some combination thereof.

The color camera 320 generates color image data for simultaneous localization and mapping (SLAM) for a position of the headset 300 and updating of a model of the local area. The color camera may include one or more RGB cameras that capture images of some or all of the local area. In some embodiments, one or both of the monochrome cameras 330 and 335 of the DCA may also function as the color camera. The images captured by the color camera and the depth information determined by the DCA may be used to determine parameters of the local area, generate a model of the local area, update a model of the local area, or some combination thereof. Furthermore, the position sensor 390 tracks the position (e.g., location and pose) of the headset 300 within the room. More details of the color camera 320 are described below in conjunction with FIG. 5.

FIG. 4A illustrates a sensor array 400 of a monochrome camera, in accordance with one or more embodiments. The monochrome camera can be an embodiment of one of the monochrome cameras of the camera assembly 230 in FIG. 2. The sensor array 400 includes an array of broadband pixels 410, each of the broadband pixels 410 is referred as a broadband pixel 410. In FIG. 4A, the sensor array 400 includes 81 broadband pixels 410. In other embodiments, the sensor array can include a different number of broadband pixels 410. In some embodiments, the broadband pixels have a passband that includes at least a part of the visible band and an infrared band.

The sensor array 400 also includes a sparse array of filter elements 420, each of the filter elements 420 is referred as a filter element 420. Each of the filter elements 420 in the sparse array has a passband that is narrower than a passband of the corresponding broadband pixel 410. Each filter element 420 in the sparse array is coupled to a broadband pixel that is located at a peripherical region of the sensor array 400. Lateral chromatic aberration at the peripherical region of the sensor array 410 is more significant than other regions of the sensor array 410. Compared with coupling the filter elements to other broadband pixels of the sensor array 410, more significant aberrations in images captured by the monochrome camera that are caused by lateral chromatic aberration can be detected.

In the embodiment of FIG. 4A, each filter element 420 includes a color filter 430 and an infrared filter 440. The color filter 430 has a passband that is a color channel of a visible band. In some embodiments, the color channel of the color filter 430 is green to optimize for correcting lateral chromatic aberration for the wavelength in the green band. In some embodiments, the color channel of the color filter 430 can be other color channels or include multiple color channels. The infrared filter 440 has a passband that is an infrared band. In some embodiments, the infrared filter 440 may have a passband that is much narrower than the color filter 430, e.g., the infrared filter 440 may have a passband that is at least 5 nanometers, such as a pass band that is between 5 nanometers and 20 nanometers. n some other embodiments, the filter elements 420 can have different filters, such as one or more hyperspectral filters that allow selective transmission of very short FWHM (full width at half maximum) light.

As shown in FIG. 4A, each filter element 420 couples to one broadband pixel 410. Also, neighboring filter elements 420 are arranged diagonally. In some embodiments, the color filter 430 and infrared filter 440 of each filter element 420 can each coupled to 50% of the corresponding broadband pixel 410. In some other embodiments, the color filter 430 and infrared filter 440 of each filter element 420 can coupled to different percentages of the broadband pixel 410. In some embodiments, each filter element 420 may couple to multiple broadband pixels 410. For instance, the color filter 430 couples to a first broadband pixel 410 and the infrared filter 440 couples to a second broadband pixel 410 that neighbors the first broadband pixel 410.

FIG. 4B illustrates another sensor array 450 of a monochrome camera, in accordance with one or more embodiments. The sensor array 450 includes an array of broadband pixels 460. The monochrome camera also includes a sparse array of filter elements 470. The filter elements 470 are coupled to broadband pixels 460 that are located either at both a peripherical region of the sensor array 450 and at a center 455 of the sensory array 450. Lateral chromatic aberration at the peripherical region of the sensor array 450 increases with distance from the center 455 of the sensor array 450, i.e., least significant aberrations (e.g., zero or minimal aberrations) are expected at the center 455 and most significant aberrations are expected at the peripherical region. Thus, by coupling the filter elements to these broadband pixels 460 of the sensor array 410, the most significant aberrations and least significant aberrations in images captured by the monochrome camera that are caused by lateral chromatic aberration can be detected. The monochrome camera in FIG. 4A or 4B can be an embodiment of one or both of the monochrome cameras 330 and 335 in FIG. 3.

FIG. 5 illustrates sensor arrays of a camera assembly comprising a color camera and two monochrome cameras, in accordance with one or more embodiments. A sensor array 510 is a sensor array of the color camera. Sensor arrays 520 and 530 are sensor arrays of the two monochrome cameras, respectively. The sensor array 510 can have a field of view that covers the field of view of the sensor arrays 520 and 530. The camera assembly can be an embodiment of the camera assembly 230 in FIG. 2.

The sensor array 510 is a red-green-blue (RGB) sensor array and captures color images of a local area. The sensor array 510 includes a plurality of RGB pixels. In some embodiments, the RGB pixels are broadband pixels covered with color filters. The sensor array 510 can be an embodiment of the color camera 320 in FIG. 3.

In FIG. 5, each of the sensor arrays 520 and 530 includes an array of broadband pixels. A sparse array of filter elements 550 are coupled to broadband pixels of the sensor array 525 that are located along a periphery of the sensor array 525. A sparse array of filter elements 560 are coupled to broadband pixels of the sensor array 535 that are located along a periphery of the sensor array 535 An embodiment of the sensor array 520 and/or 530 is the sensor array 460 in FIG. 4B. An embodiment of the filter elements 550 and/or 560 is the filter element 420 in FIG. 4A. The monochrome cameras 520 and 530 can be an embodiment of the monochrome cameras 330 and 335 in FIG. 3.

In some embodiments, lateral chromatic aberration in the monochrome images can be corrected by using the color images captured by the sensor array 510. The sensor arrays 510, 520, and 530 can each capture one or more images of a target image. A controller, e.g., the controller 240, can map a color image captured by the sensor array 510 to a stereo image generated from the images captured by the sensor arrays 520 and 530. The controller can determine offsets based on the mapping. For instance, the controller maps a portion of the color image corresponding to a blue pixel 570 of the sensor array 510 to a corresponding portion of the stereo image. The portion of the stereo image is generated by image data captured by a broadband pixel 580 of the sensor array 520 and a broadband pixel 590 of the sensor array 530. The controller compares the portion of the stereo image with the corresponding portion of the target image to determine offsets in the stereo image. The determined offsets are for the blue band. The controller further applies the offsets for the blue band to the broadband pixels 580 and 590 to correct for lateral chromatic aberration of these broadband pixels 580 and 590 at the blue channel. Similarly, the controller can correct for lateral chromatic aberration of broadband pixels of the sensor arrays 520 and 530 at other color channels, such as red.

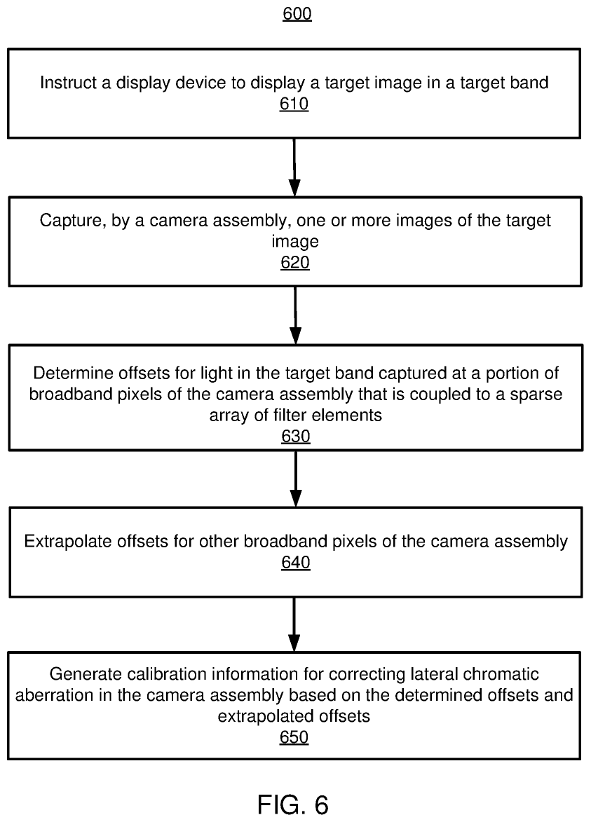

FIG. 6 is a flowchart illustrating a method 600 for generating calibration information used for correcting lateral chromatic aberration, in accordance with one or more embodiments. The method 600 may be performed by the camera calibration system 200 in FIG. 2. Other entities, such other components of a headset, may perform some or all of the steps in FIG. 6 in other embodiments. Embodiments may include different and/or additional steps, or perform the steps in different orders.

The camera calibration system 200 instructs 610 a display device to display a target image in a target band. In some embodiments, the target image includes a target pattern, such as a sine wave pattern. The target band can be a color channel of the visible band (such as red, green, blue, etc.) or an infrared band.

The camera calibration system 200 captures 620, by a camera assembly, one or more images of the target image. The camera assembly can be the camera assembly 230 that includes at least two monochrome cameras. Each monochrome camera can be the monochrome camera in FIG. 3, 4A, or 4B.

The camera calibration system 200 determines 630 offsets for light in the target band captured at a portion of the broadband pixels that is coupled to the sparse array of filter elements. An offset is a decrease or increase in the captured light. In some embodiments, the offsets are determined based on portions of the one or more captured images that correspond to the portion of the broadband pixels. The portions of each captured image are extracted and compared to corresponding portions of the target image. Based on the comparison, differences between the extracted portions of each captured image and the corresponding portions of the target image are determined, which represent aberrations in the portions of the captured images caused by lateral chromatic aberration. The offsets are then determined to counterbalance the aberrations in the extracted portions.

The camera calibration system 200 extrapolates 640 offsets for other broadband pixels the camera assembly. The offsets for the other broadband pixels may be extrapolated based on the offsets determined in step 620 and the respective positions of the other broadband pixels. For example, the camera calibration system 200 may predict for the target band an amount of aberration as a function of distance from a center of the sensor array. In some embodiments, the camera calibration system 200 sets chromatic aberration at the center of the sensor array to zero or some known fixed value (e.g., could be from a determined offset and/or a predetermined value). The camera calibration system 200 determines an offset function that describes as a function of distance from the center of the sensor array how offset changes. The camera calibration system 200 determines the offset function using the determined offset values and information describing an optical assembly of the camera (e.g., indices of refraction, curvature of surfaces, lens thickness, etc.). For some or all of the broadband pixels, the camera calibration system 200 applies respective positions of the broadband pixels to the offset function to determine their respective offsets.

The camera calibration system 200 generates 650 calibration information for correcting lateral chromatic aberration in the camera assembly based on the determined offsets and extrapolated offsets. The calibration information includes information describing offsets for light in the target band as a function of positions of at least some of the plurality of broadband pixels. For instance, the calibration information specifies the position of each broadband pixel and an offset corresponding to that broadband pixel. In some embodiments, the calibration information includes information describing offsets for light in the target band as a function of positions of all the broadband pixels of the sensor array. Also, calibration information for light in other bands can also be determined.

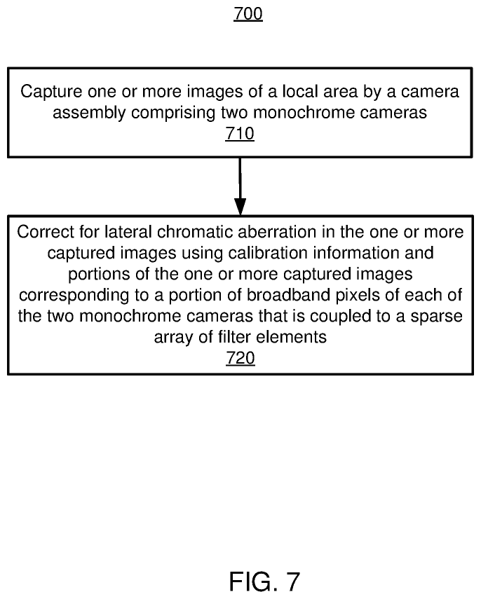

FIG. 7 is a flowchart illustrating a method 700 for correcting lateral chromatic aberration, in accordance with one or more embodiments. The method 700 may be performed by an imaging system (e.g., on a headset). Other entities may perform some or all of the steps in FIG. 7 in other embodiments. Embodiments may include different and/or additional steps, or perform the steps in different orders.

The imaging system captures 710 one or more images of a local area by a camera assembly comprising two monochrome cameras. The camera assembly can be the camera assembly 230 that includes two monochrome cameras. Each monochrome camera can be the monochrome camera in FIG. 3, 4A, or 4B.

The imaging system corrects 720 for lateral chromatic aberration in the one or more captured images using calibration information and portions of the one or more captured images corresponding to the portion of the broadband pixels of each of the two monochrome cameras that is coupled to the sparse array of filter elements. The calibration information can be the calibration information generated by using the method 600 in FIG. 6. As the calibration information describes offsets for light in a target band as a function of positions of at least some of the broadband pixels of the monochrome cameras, the offsets can be applied to portions of each captured image that correspond to the positions of the broadband pixels to counterbalance aberrations in the portions of the captured imaged. The corrected images can be used to determine the depth information of the local area. Each captured image can be a stereo image that is generated by combining images captured by the two monochrome cameras. Depth information can be extracted from the captured images.

The camera calibration system 200 is advantageous over conventional techniques that use an achromatic optical element to correct image aberrations caused by lateral chromatic aberration. The camera calibration system 200 provides a flexible way to incorporate lateral chromatic aberration correction. It does not require additional optical components other than overlaying the existing sensor array of the camera with filter elements. It also does not increase form factor or volume of the headset. Compared with the conventional techniques, it reduces complexity of module design and is less expensive. For example, it uses monochromatic cameras that have high signal-noise-ratio and broader band than color cameras. Also, monochrome cameras are less expensive than using color cameras.

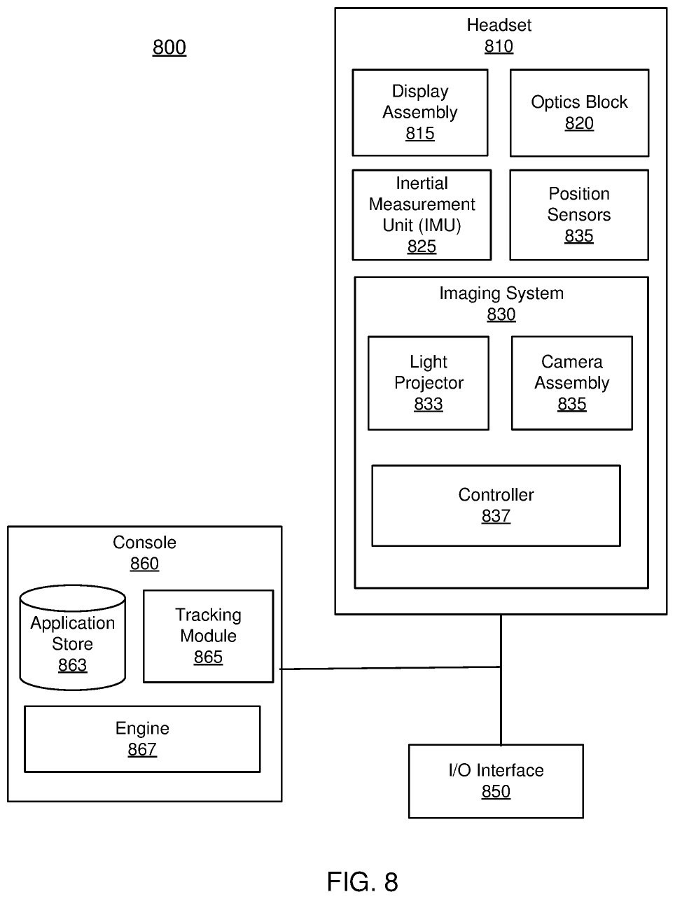

FIG. 8 is a block diagram of a system 800 that includes a headset 810, in accordance with one or more embodiments. The system 800 may operate in an artificial reality environment, e.g., a virtual reality, an augmented reality, a mixed reality environment, or some combination thereof. The system 800 shown by FIG. 8 includes a headset 810 and an input/output (I/O) interface 840 that are coupled to a console 860. While FIG. 8 shows an example system 800 including one headset 810 and one I/O interface 850, in other embodiments any number of these components may be included in the system 800. For example, there may be multiple headsets 810 each having an associated I/O interface 850, with each headset 810 and I/O interface 850 communicating with the console 860. In alternative configurations, different and/or additional components may be included in the system 800. Additionally, functionality described in conjunction with one or more of the components shown in FIG. 8 may be distributed among the components in a different manner than described in conjunction with FIG. 8 in some embodiments. For example, some or all of the functionality of the console 860 may be provided by the headset 810.

The headset 810 includes a display assembly 815, an optics block 820, an inertial measurement unit (IMU) 825, an imaging system 830, one or more position sensors 835, and a color camera 875. Some embodiments of the headset 810 have different components than those described in conjunction with FIG. 8. Additionally, the functionality provided by various components described in conjunction with FIG. 8 may be differently distributed among the components of the headset 810 in other embodiments, or be captured in separate assemblies remote from the headset 810. An embodiment of the headset 810 is the headset 300 in FIG. 3.

The display assembly 815 may include an electronic display that displays 2D or 3D images to the user in accordance with data received from the console 860. The images may include images of the local area of the user, images of virtual objects that are combined with light from the local area, images of a virtual area, or some combination thereof. The virtual area may be mapped a real room that is distant from the user. In various embodiments, the display assembly 815 comprises a single electronic display or multiple electronic displays (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof.

The optics block 820 magnifies image light received from the electronic display, corrects optical errors associated with the image light, and presents the corrected image light to a user of the headset 810. In various embodiments, the optics block 820 includes one or more optical elements. Example optical elements included in the optics block 820 include: an aperture, a Fresnel lens, a convex lens, a concave lens, a filter, a reflecting surface, or any other suitable optical element that affects image light. Moreover, the optics block 820 may include combinations of different optical elements. In some embodiments, one or more of the optical elements in the optics block 820 may have one or more coatings, such as partially reflective or anti-reflective coatings.

Magnification and focusing of the image light by the optics block 820 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 820 may be designed to correct one or more types of optical error. Examples of optical error include barrel or pincushion aberration, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 820 corrects the aberration after it receives image light from the electronic display generated based on the content.

The IMU 825 is an electronic device that generates data indicating a position of the headset 810 based on measurement signals received from one or more of the position sensors 835. A position sensor 835 generates one or more measurement signals in response to motion of the headset 810. Examples of position sensors 835 include: one or more accelerometers, one or more gyroscopes, one or more magnetometers, another suitable type of sensor that detects motion, a type of sensor used for error correction of the IMU 825, or some combination thereof. The position sensors 835 may be located external to the IMU 825, internal to the IMU 825, or some combination thereof.

The imaging system 830 generates visual information of a target area, such as a room. The visual information may include, e.g., depth information, color information, etc. The imaging system 830 in FIG. 8 includes a light projector 833, camera assembly 835, and a controller 837.

The light projector 833 may project a structured light pattern or other light (e.g., infrared flash for time-of flight) that is reflected off objects in the target area, and captured by the monochrome camera 835 to generate the depth image data. For example, the light projector 833 may project a plurality of structured light (SL) elements of different types (e.g. lines, grids, or dots) onto a portion of a target area surrounding the headset 810. In various embodiments, the light projector 833 comprises an emitter and a diffractive optical element. The emitter is configured to illuminate the diffractive optical element with light (e.g., infrared light). The illuminated diffractive optical element projects a SL pattern comprising a plurality of SL elements into the target area. For example, each of the SL elements projected by the illuminated diffractive optical element is a dot associated with a particular location on the diffractive optical element. The SL pattern projected into the target area by the imaging system 830 deforms as it encounters various surfaces and objects in the target area.

The camera assembly 835 captures image data of the target area. In some embodiments, the camera assembly 835 includes one or more sets of cameras that image in stereo. A set of cameras can include two monochrome cameras that are each configured to capture depth image data of the target area. Depth image data includes pixel values defining distance from the monochrome camera, and thus provides a (e.g., 3D) mapping of locations captured in the depth image data. An image captured by a monochrome camera may include a plurality of SL elements (e.g., dots) projected by the light projector 833 and reflected by the objects in the target area.

Each monochrome camera includes a sensor array that includes a number of broadband pixels for capturing the images. The monochrome camera also includes a sparse array of filter elements for correcting for lateral chromatic aberration in the captured images. Each of the filter elements is coupled to a broadband pixel at a periphery or center of the sensor array and has a passband that is narrower than a passband of the corresponding broadband pixel. For instance, the passband of the broadband pixels includes the visible band and an IR band, and the passband of the filter elements can be a color channel of a visible band and/or an IR band. An embodiment of each monochrome camera is the monochrome camera 400 in FIG. 4A or the monochrome camera 450 in FIG. 4B.

The camera assembly 835 can also include a color camera that captures color image data of the target area. The color camera includes one or more passive cameras that generate color (e.g., RGB) image data. Unlike the monochrome cameras that uses active light emission and reflection, the color camera captures light from the environment of a target area to generate image data. Rather than pixel values defining depth or distance from the monochrome camera, the pixel values of the image data may define the visible color of objects captured in the imaging data. Images captured by the color camera can be used to correct for lateral chromatic aberration in images taken by the monochrome cameras.

The controller 837 corrects for lateral chromatic aberration in the captured images based on calibration information that describing offset for light in a target band as a function of positions of at least some of the broadband pixels. The controller 837 then uses the corrected images to generate depth information. The controller 837 may further provide the depth information to the console 860, the audio controller 420, or some other component. An embodiment of the controller 837 is the controller 240 described above in conjunction with FIG. 2.

In some embodiments, the controller 837 generates a three-dimensional (3D) mesh of the target area based on the depth image data. The 3D mesh may include points and/or lines that represent boundaries of the target area. The controller 837 can also combine the 3D mesh with the color image data generated by the color camera to generate a 3D virtual representation of the target area. The 3D virtual representation may include virtual representation of surfaces within the target area, such as walls, ceiling, floor, surfaces of furniture, surfaces of appliances, surfaces of other types of objects, and so on.

In some embodiments, the light projector 833 projects light pulses that are reflected off of objects in the local area, and captured by the monochrome cameras to generate the depth image data by using time-of-flight techniques. For example, the light projector 833 projects infrared flash for time-of-flight. The monochrome cameras capture the infrared flash reflected by the objects. The controller 837 can use image data from the monochrome cameras to determine distances to the objects. The controller 837 may provide instructions to the monochrome cameras so that the monochrome cameras capture the reflected light pulses in synchronization with the projection of the light pulses by the light projector 833.

The I/O interface 850 is a device that allows a user to send action requests and receive responses from the console 860. An action request is a request to perform a particular action. For example, an action request may be an instruction to start or end capture of image or video data, or an instruction to perform a particular action within an application. The I/O interface 850 may include one or more input devices. Example input devices include: a keyboard, a mouse, a game controller, or any other suitable device for receiving action requests and communicating the action requests to the console 860. An action request received by the I/O interface 850 is communicated to the console 860, which performs an action corresponding to the action request. In some embodiments, the I/O interface 850 includes the IMU 825, as further described above, that captures calibration data indicating an estimated position of the I/O interface 850 relative to an initial position of the I/O interface 850. In some embodiments, the I/O interface 850 may provide haptic feedback to the user in accordance with instructions received from the console 860. For example, haptic feedback is provided after an action request is received, or the console 860 communicates instructions to the I/O interface 850 causing the I/O interface 850 to generate haptic feedback after the console 860 performs an action.

The console 860 provides content to the headset 810 for processing in accordance with information received from one or more of: the imaging system 830, the color camera 840, the headset 810, and the I/O interface 850. In the example shown in FIG. 8, the console 860 includes an application store 863, a tracking module 865, and an engine 867. Some embodiments of the console 860 have different modules or components than those described in conjunction with FIG. 8. Similarly, the functions further described below may be distributed among components of the console 860 in a different manner than described in conjunction with FIG. 8. In some embodiments, the functionality discussed herein with respect to the console 860 may be implemented in the headset 810, or a remote system.

The application store 863 stores one or more applications for execution by the console 860. An application is a group of instructions, that when executed by a processor, generates content for presentation to the user. Content generated by an application may be in response to inputs received from the user via movement of the headset 810 or the I/O interface 850. Examples of applications include: gaming applications, conferencing applications, video playback applications, or other suitable applications.

The tracking module 865 calibrates the local area of the system 800 using one or more calibration parameters and may adjust one or more calibration parameters to reduce error in determination of the position of the headset 810 or of the I/O interface 850. For example, the tracking module 865 communicates a calibration parameter to the imaging system 830 to adjust the focus of the imaging system 830 to more accurately determine positions of SL elements captured by the imaging system 830. Calibration performed by the tracking module 865 also accounts for information received from the IMU 825 in the headset 810 and/or an IMU 825 included in the I/O interface 850. Additionally, if tracking of the headset 810 is lost (e.g., the imaging system 830 loses line of sight of at least a threshold number of the projected SL elements), the tracking module 865 may re-calibrate some or all of the system 800.

The tracking module 865 tracks movements of the headset 810 or of the I/O interface 850 using information from the imaging system 830, the color camera 840, the one or more position sensors 835, the IMU 825 or some combination thereof. For example, the tracking module 865 determines a position of a reference point of the headset 810 in a mapping of a local area based on information from the headset 810. The tracking module 865 may also determine positions of an object (real object or virtual object) in the local area or a virtual area. Additionally, in some embodiments, the tracking module 865 may use portions of data indicating a position of the headset 810 from the IMU 825 as well as representations of the local area from the imaging system 830 to predict a future location of the headset 810. The tracking module 865 provides the estimated or predicted future position of the headset 810 or the I/O interface 850 to the engine 867.

The engine 867 executes applications and receives position information, acceleration information, velocity information, predicted future positions, or some combination thereof, of the headset 810 from the tracking module 865. Based on the received information, the engine 867 determines content to provide to the headset 810 for presentation to the user. For example, if the received information indicates that the user is at a position of a target area, the engine 867 generates virtual content (e.g., images and audio) associated with the target area. The target area may be a virtual area, e.g., a virtual conference room. The engine 867 can generate images of the virtual conference room and speeches given in the virtual conference room for the headset 810 to display to the user. The target area may be a local area of the user. The engine 867 can generate images of virtual objects combined with real objects from the local area and audio content associated with a virtual object or a real object. As another example, if the received information indicates that the user has looked to the left, the engine 867 generates content for the headset 810 that mirrors the user's movement in a virtual target area or in a target area augmenting the target area with additional content. Additionally, the engine 867 performs an action within an application executing on the console 860 in response to an action request received from the I/O interface 850 and provides feedback to the user that the action was performed. The provided feedback may be visual or audible feedback via the headset 810 or haptic feedback via the I/O interface 850.

### ADDITIONAL CONFIGURATION INFORMATION

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera calibration system comprising:
a camera assembly configured to capture one or more images of a local area, the camera assembly comprising at least two monochrome cameras, each monochrome camera comprising:
a sensor array including a plurality of broadband pixels, and
a sparse array of filter elements coupled to a portion of the broadband pixels and at least some of the portion of the broadband pixels are along a periphery of the sensor array, the filter elements each having a respective passband that is narrower than a passband of the broadband pixels; and
a controller configured to correct for lateral chromatic aberration in the one or more captured images using calibration information and portions of the one or more images of the local area corresponding to the portion of the broadband pixels that are coupled to the sparse array of filter elements.

2. The camera calibration system of claim 1, wherein the calibration information comprises information describing offset for light in a target band as a function of positions of at least some of the plurality of broadband pixels.

3. The camera calibration system of claim 2, wherein the one or more capture images are one or more images of a target image in the target band, and the controller is further configured to:
determine offsets for light in the target band captured at the portion of the broadband pixels that is coupled to the sparse array of filter elements using the portions of the one or more captured images; and
extrapolate offsets for other broadband pixels of the sensor array of the monochrome camera.

4. The camera calibration system of claim 2, wherein the target band comprises a color channel of a visible band.

5. The camera calibration system of claim 1, wherein a subset of the portion of the broadband pixels are at a center of the sensor array,

6. The camera calibration system of claim 1, wherein the broadband pixels have a passband that includes a visible band and an infrared band.

7. The camera calibration system of claim 6, wherein the passband of the filter elements is at least one of a color channel of a visible band and an infrared band.

8. The camera calibration system of claim 7, wherein the color channel is green.

9. The camera calibration system of claim 1, wherein the passband of a first portion of the filter elements is in an infrared band and has a bandwidth of at least 5 nanometers, and the controller is further configured to:
detect a wavelength shift in light filtered by the portion of the filter elements and captured by a corresponding portion of the broadband pixels, wherein at least some of the captured light is from a peripheral device; and
instruct the peripheral device to adjust a wavelength of the emitted light, and an amount of adjustment is based in part on the detected wavelength shift.

10. The camera calibration system of claim 1, wherein the controller is further configured to:
detect a brightness in ambient light filtered by the portion of the filter elements and captured by a corresponding portion of the broadband pixels; and
instruct an illuminator to adjust brightness of light emitted by the illuminator, and an amount of adjustment is based in part on the detected brightness of the ambient light.

11. The camera calibration system of claim 1, wherein the controller is further configured to use the one or more corrected images to generate depth information for the local area.

12. The camera calibration system of claim 1, further comprising a color camera comprising a red-green-blue (RGB) sensor array including a plurality of RGB pixels, the RGB sensor array configured to capture one or more RGB images of a local area, wherein the controller is further configured to correct for lateral chromatic aberration in the one or more captured images based in part on the one or more RGB images.

13. A method comprising:
capturing one or more images of a local area by a camera assembly comprising at least two monochrome cameras, each monochrome camera comprising:
a sensor array including a plurality of broadband pixels, and
a sparse array of filter elements coupled to a portion of the broadband pixels and at least some of the portion of the broadband pixels are along a periphery of the sensor array, the filter elements each having a respective passband that is narrower than a passband of the broadband pixels; and
correcting for lateral chromatic aberration in the one or more captured images using calibration information and portions of the one or more captured images corresponding to the portion of the broadband pixels that are coupled to the sparse array of filter elements.

14. The method of claim 13, wherein the calibration information comprises information describing offset for light in a target band as a function of positions of at least some of the plurality of broadband pixels.

15. The method of claim 14, further comprising:
capturing one or more images of a target image in the target band;
determining, by using the portions of the one or more captured images, offsets for light in the target band captured at the portion of the broadband pixels that is coupled to the sparse array of filter elements; and
extrapolating offsets for other broadband pixels of the sensor array of the monochrome camera.

16. The method of claim 14, wherein the target band comprises a color channel of a visible band.

17. The method of claim 13, wherein the passband of a first portion of the filter elements is in an infrared band and has a bandwidth of at least 5 nanometers, and the method further comprising:
detecting a wavelength shift in light filtered by the portion of the filter elements and captured by a corresponding portion of the broadband pixels, wherein at least some of the captured light is from a peripheral device; and
instructing the peripheral device to adjust a wavelength of the emitted light, and an amount of adjustment is based in part on the detected wavelength shift.

18. The method of claim 13, further comprising:
detecting a brightness in ambient light filtered by the portion of the filter elements and captured by a corresponding portion of the broadband pixels; and
instructing an illuminator to adjust brightness of light emitted by the illuminator, and an amount of adjustment is based in part on the detected brightness of the ambient light.

19. A method comprising:
capturing, by a camera assembly, one or more images of a target image in a target band, the camera assembly comprising at least two monochrome cameras, each monochrome camera comprising:
a sensor array including a plurality of broadband pixels, the sensor array configured to capture one or more images of a local area, and
a sparse array of filter elements coupled to a portion of the broadband pixels and at least some of the portion of the broadband pixels are along a periphery of the sensor array, the filter elements each having a respective passband that is narrower than a passband of the broadband pixels;
determining offsets for light in the target band captured at the portion of the broadband pixels that is coupled to the sparse array of filter elements;
extrapolating offsets for other broadband pixels of the sensor array of the monochrome camera; and
generating calibration information for correcting lateral chromatic aberration in the camera assembly based on the determined offsets and extrapolated offsets, the calibration information comprising information describing offset for light in a target band as a function of positions of at least some of the plurality of broadband pixels.

20. The method of claim 19, wherein the target band comprises a color channel of a visible band.
